(19) United States
(12) Patent Application Publication
(10) Pub. No.: US 2016/0165455 A1
(43) Pub. Date: Jun. 9, 2016

(54) Method for configuring a wireless network and central station for a wireless network

(71) Applicant: Robert Bosch GmbH, Stuttgart (DE)

(72) Inventors: Johannes LANGBEIN, Stuttgart (DE); Matthias Besemer, Offenau (DE); Thorsten Dobelmann, Stuttgart (DE); Jan Loebel, Schwaikheim (DE); Heribert Hirth, Stuttgart (DE); Tobias Farrell, Lichtenwald (DE); Dominic Schabel, Ludwigsburg (DE); Michael Witzel, Fellbach (DE)

(21) Appl. No.: 14/946,472

(22) Filed: Nov. 19, 2015

(30) Foreign Application Priority Data
Dec. 3, 2014 (DE) 10 2014 224 781.0

(51) Int. Cl. H04W 16/18; H04L 12/24

(52) U.S. Cl. CPC H04W 16/18; H04L 41/0886; H04L 41/0806

(57) ABSTRACT

A method for configuring a wireless network or a central station of a wireless network including at least the central station and at least two peripheral stations, includes in a first task, the central station ascertaining the peripheral stations which are reachable by wireless signals of the central station. In a second task, the central station configures at least one of the peripheral stations, which were ascertained in the first task, test-wise as a repeater, which receives and re-transmits the wireless signals of the central station. If the central station ascertains that more peripheral stations are reachable by the central station via the repeater, in a third task, the central station configures the peripheral stations, configured test-wise as repeaters, permanently as repeaters.

### RELATED APPLICATION INFORMATION

The present application claims priority to and the benefit of German patent application no. 10 2014 224 781.0, which was filed in Germany on Dec. 3, 2014, the disclosure of which is incorporated herein by reference.

### FIELD OF THE INVENTION

The present invention is directed to a method or a central station.

BACKGROUND INFORMATION

Wireless networks or central stations for wireless networks are believed to be understood in which a central station and peripheral stations are known. Of these peripheral stations, specific ones may also be used as repeaters in which a peripheral station of this type used as a repeater repeats wireless signals of the central stations.

### SUMMARY OF THE INVENTION

The method according to the present invention for configuring a wireless network or the central station for a wireless network according to the definition of the species in the descriptions herein is believed to have the advantage over the related art that a configuration of a peripheral station as a repeater is automated. It is therefore not necessary to plan in advance a structure of the wireless network to include a central station, at least one repeater and additional peripheral stations, but instead the structure of this wireless network may be automated. This thus makes it possible for a user of the wireless network to put it into operation immediately and not be required or be only minimally required to be involved with the design or configuration of the network. Furthermore, the possibility is provided for automatically re-configuring the wireless network, in particular in the case of a change of the individual stations, in particular in the case of a change in position of the individual stations.

Additional advantages and improvements ensue from the features of the further descriptions herein. The determination in the permanent configuration, of for and from which peripheral station wireless signals from the repeater are repeated, makes it possible to keep the number of wireless signals in the wireless network low. In particular, a potential radiation exposure in the area of the wireless network is thus kept low. Furthermore, a bandwidth available for the wireless network may be optimally utilized. For ascertaining which peripheral stations are reached by a repeater, it may be provided that in the test-wise configuration as a repeater, the repeater repeats wireless signals for and from a plurality of peripheral stations. The selection of the peripheral stations which are configured test-wise as repeaters is advantageously carried out by the central station. Furthermore, the central station may start the test-wise configuration of individual peripheral stations as repeaters, if the central station detects that one of the peripheral stations, which should be reachable by the central station, is not reached. For the selection of which peripheral stations are configured test-wise as repeaters, the signal strength of the wireless signal between the central station and the peripheral station may be considered. Alternatively, another possibility is a random selection of the peripheral station, which is configured test-wise as a repeater. If a plurality of peripheral stations is present, different configurations of repeaters may be tried out until a minimum number of repeaters, which are necessary for reaching all peripheral stations, are ascertained. In this way, it is possible to minimize the number of peripheral stations which are configured as repeaters. This makes it possible to optimally utilize the available bandwidth of the wireless network.

Exemplary embodiments of the present invention are represented in the drawings and are elucidated in greater detail in the following description.

### BRIEF DESCRIPTION OF THE DRAWINGS

FIG. 1 shows a first wireless network.

FIG. 2 shows another wireless network.

FIG. 3 shows the method according to the present invention.

### DETAILED DESCRIPTION

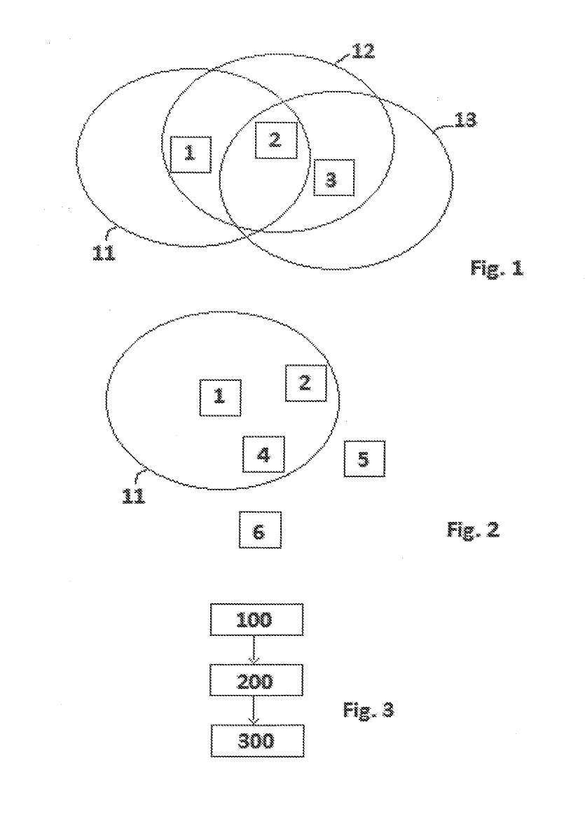

In FIG. 1, a wireless network is shown including a central station 1, a peripheral station 2 and another peripheral station 3. Each of the stations shown, i.e., central station 1 and peripheral stations 2, 3, transmit and receive wireless signals and thus exchange data among one another. The range of this data exchange, i.e., the wireless range, is represented by a circle surrounding the respective station. Central station 1 thus has a range 11, peripheral station 2 has a range 12, and peripheral station 3 has a range 13. Within this range, the wireless signals transmitted by the particular station may be received. As is apparent in FIG. 1 by comparing the particular ranges of the wireless signals of the individual stations, it is not possible for all stations to exchange data with one another. Peripheral station 2 is situated within range 11 of the wireless signals of central station 1. This means that peripheral station 2 is able to receive wireless signals of central station 1. Furthermore, central station 1 is situated within range 12 of peripheral station 2. This means that central station 1 is able to receive wireless signals which are transmitted from peripheral station 2. Peripheral station 3 is not within range 11 of central station 1. Therefore, peripheral station 3 is not able to receive wireless signals from central station 1. Conversely, central station 1 is not within range 13 of peripheral station 3, so that central station 1 is not able to either receive signals transmitted from peripheral station 3. As a result, from a comparison of the positions of peripheral stations 2 and 3 and particular ranges 12 and 13, peripheral stations 2 and 3 are each able to receive the wireless signals transmitted from the other station. The situation of FIG. 1 may be summarized as follows:

Stations 1 and 2 are able to exchange data with one another and stations 2 and 3 are able to exchange data with one another; however, stations 1 and 3 are not able to exchange data with one another.

The present invention now relates to the configuration of such a wireless network including at least one central station 1 and at least two peripheral stations 2, 3. It is usually the case that central station 1 is configured to be more complex than peripheral stations 2, 3. It is customary that central station 1 is a central station 1 having a computer which is able to carry out complex control tasks. Peripheral stations 2, 3 are, in contrast, relatively simple in design and are only able to respond passively to commands of central station 1. Such a constellation is present, for example, when station 1 is a central control station of a control network and peripheral stations 2 or 3 are individually activated stations of the control network. For example, the stations may be installed in a house, central station 1 being a central control computer and peripheral stations 2 or 3 dealing with individual control functions in the house, for example, control of a heating system, control of an individual radiator, a lighting system, a washing machine, a dishwasher or a refrigerator.

The present invention now relates to the configuration of such a wireless network. In an initial state, no relations between the individual stations are defined. The individual method steps with respect to a configuration of the wireless network are described in FIG. 3. In a first step 100, central station 1 initially ascertains which peripheral stations lie within range 11 of central station 1. For this purpose, central station 1 transmits a command, via which peripheral stations 2 lying within range 11 of central station 1 are prompted in turn to transmit a signal to central station 1. The return of this signal from peripheral station 2 to central station 1 makes it apparent to central station 1 which peripheral stations are located within wireless range 11 of central station 1. Via this step 100, central station 1 is thus made aware of which peripheral stations may be reached by the wireless signals of central station 1.

Step 100 is subsequently followed by a step 200, in which at least one of the peripheral stations found in step 100 is configured test-wise as a repeater. In the constellation of FIG. 1, this may only be peripheral station 2. Configuration in this case means that on the one hand, peripheral station 2 operates as a repeater, i.e., it repeats the wireless signals it receives from central station 1 and through this repetition, it expands wireless range 11 of the first station by range 12 of peripheral station 2. Such repetition of the wireless signals of central station 1 consequently increases the wireless range of central station 1.

Since such repetition of wireless signals, at least in the area in which wireless ranges 11 and 12 overlap, causes the number of wireless signals to increase, the amount of electromagnetic interferences increases in this area or the available bandwidth in this area is halved. It is therefore advantageous if the configuration includes not only the fact that the peripheral station repeats wireless signals of station 1, but instead that peripheral station 2 does not generally repeat all wireless signals of station 1, but only a selection. This selection of wireless signals that are repeated by peripheral station 2 is based on which peripheral stations, for example, peripheral station 3 in this case, are only in the area of wireless range 12 of peripheral station 2 and not in the area of wireless range 11 of central station 1. Such a detailed configuration, in which only some of the wireless signals of central station 1 are repeated, makes it possible to reduce significantly the quantity of wireless signals in the network. However, to make such a selection of messages which are repeated, more accurate knowledge of the other accessible peripheral stations is required. If a command is now transmitted from the central station, via which peripheral station 3 is prompted to transmit a wireless signal, this signal is repeated by peripheral station 2 configured as a repeater in step 200. As a result of this repetition, this command also reaches peripheral station 3, which subsequently transmits a corresponding signal in response to this command. Since wireless range 13 of peripheral station 3 does not reach central station 1, this wireless signal from peripheral station 3 is then repeated by peripheral station 2 and thus also reaches central station 1. In this way, central station 1 thus is made aware that peripheral station 3 may be reached via peripheral station 2 configured as a repeater. At this point in time, central station 1 consequently has an awareness of all peripheral stations 2, 3 of the wireless network, and furthermore, information concerning which stations are only reachable via a repeater. Step 200 is subsequently followed by step 300, in which this knowledge is used for a final configuration of the wireless network. For this purpose, central station 1 will configure peripheral station 2 permanently as a repeater for peripheral station 3, since only in this way is it possible for peripheral station 3 to be appropriately activated by central station 1 or for central station 1 to be able to receive signals of peripheral station 3. With the final permanent configuration of peripheral station 2 as a repeater for peripheral station 3, the method is consequently terminated.

Essential to this method according to FIG. 3 is that central station 1 has advance knowledge of which peripheral stations 2, 3 it will subsequently want to reach. For this purpose, it is necessary to introduce this information in central station 1 prior to the configuration of the wireless network. Alternatively, other methods are also possible, in which central station 1 ascertains which peripheral stations are in principle reachable. For this purpose, a piece of information would additionally be needed in first step 100 that central station 1 and peripheral station 2 are also provided for data exchange with one another. This may, for example, be that the case where peripheral station 2 contains an identifier that characterizes it as a peripheral station which is configured for communicating with central station 1. A method may also be provided in which a user of this wireless network enters additional commands to enable a data exchange between central station 1 and peripheral station 2.

For example, the user may be informed on central station 1 that a peripheral station 2 has been found and that this peripheral station is considered to be authorized to communicate with central station 1, when an input is made by the user directly on peripheral station 2. This may, for example, also be limited to a short period of time, for example, 1 or 2 minutes. If peripheral station 2 is subsequently configured as a repeater in step 200, it is apparent to central station 1 that yet another peripheral station 3 was found in the area of range 12 of repeater 2. Accordingly, a user of the wireless network may then be prompted to enter authorization information on peripheral station 3 such as, for example, a pin or an acknowledge signal within a short period of time. If this authorization is then provided by the user, the piece of information is accordingly stored in peripheral station 1 that peripheral station 3 may be reached via repeater 2. Both methods are therefore possible, in the first method, central station 1 containing the information in advance concerning which peripheral stations 2, 3 would have to be reachable. In the other method, this information regarding reachable peripheral stations 2, 3 may be ascertained by additional inputs of a user during the configuration.

In FIG. 2 another wireless network is shown which, compared to FIG. 1, has a higher number of peripheral stations.

Shown in FIG. 2 is a central station 1 and corresponding wireless range 11 of central station 1. Within wireless range 11 of central station 1 are found peripheral stations 2 and 4. This means that central station 1 and peripheral station 2 are able to exchange data with one another and central station 1 and peripheral station 4 are able to exchange data with one another. The additional wireless ranges of peripheral stations 2, 4, 5, 6 are not shown graphically in FIG. 2. It is the case that peripheral station 2 is able to exchange data with peripheral station 5. Furthermore, peripheral station 4 may exchange data with peripheral station 5 and with peripheral station 6. Different possibilities for configuring the wireless network now ensue. Station 5 may, for example, exchange data with central station 1 if peripheral station 2 is configured as a repeater. Furthermore, station 5 may exchange data with central station 1 if peripheral station 4 is configured as a repeater. Station 6 may only exchange data with central station 1 if peripheral station 4 is configured as a repeater.

A first configuration of the wireless network of FIG. 2 may be that peripheral station 2 is used as a repeater for peripheral station 5. Peripheral station 4 is used as a repeater for peripheral station 6. Alternatively, yet another configuration is possible, in which peripheral station 4 is used as a repeater for peripheral stations 5 and 6. Peripheral station 2 would then not be used as a repeater. The second configuration is believed to be optimal, since in this way only a minimal quantity of stations must be configured as repeaters. It is thus possible to reduce a volume of wireless messages, and the administrative complexity in the entire wireless system may be minimized. In a particular constellation, for example, when station 4 may only be used as a repeater for another peripheral station, it is, however, possible to sidestep the other configuration.

To ascertain all possible configurations in the example according to FIG. 2, it is essential that in the test-wise operation as a repeater, each peripheral station which is configured as a repeater for testing purposes initially tries to reach all possible stations. This means that in the test-wise configuration of station 2 as a repeater, it is attempted to reach all additional stations 5 and 6. Likewise, in the test-wise configuration of peripheral station 4, it is attempted to reach all stations 5, 6, even if, for example, it has already been established in a previous step that station 5 may be reached via station 2. In the test-wise operation of a station as a repeater, the peripheral station configured as a repeater will thus repeat the wireless signals for and from a plurality of peripheral stations.

Furthermore, the central station must select which peripheral stations are configured test-wise as repeaters, and in what order. For this purpose, for example, the strength of a wireless signal may then also be considered. For example, if a peripheral station is assumed to be more likely in the border area of wireless range 11 of central station 1, it is thus certainly more likely that a peripheral station lying further outside may be reached via this station than via a station which is situated in the immediate proximity of central station 1. Alternatively, however, it may at least be attempted in a first configuration to configure all peripheral stations sequentially as repeaters. If the shortcomings of test-wise configurations of peripheral stations as repeaters are to be limited, individual stations may also be picked out entirely randomly from time to time and configured test-wise as repeaters.

What is claimed is:

1. A method for configuring a wireless network, including at least one central station and at least two peripheral stations, the method comprising:
ascertaining, in a first task, the peripheral stations, which are reachable by wireless signals of the central station;
configuring, in a second task, at least one of the peripheral stations, which was ascertained in the first task, test-wise as a repeater, which receives wireless signals of the central station and re-transmits them, and ascertaining whether more peripheral stations are reachable by the central station via the repeater; and
if this is the case, in a third task, the peripheral stations which were configured test-wise as repeaters, are permanently configured as repeaters.

2. The method of claim 1, wherein in the permanent configuration, it is established which peripheral station for and from which peripheral stations wireless signals are repeated by the repeater.

3. The method of claim 1, wherein in the test-wise configuration, the peripheral station configured test-wise repeats wireless signals for and from a plurality of peripheral stations.

4. The method of claim 1, wherein the central station contains a list including possible peripheral stations and starts a test-wise configuration as repeaters, if one of the peripheral stations of the list is not reachable.

5. The method of claim 1, wherein the selection of the peripheral stations, which are configured test-wise as repeaters, occurs based on the signal strength of a wireless signal between the central station and the peripheral station.

6. The method of claim 1, wherein the selection of the peripheral station, which is configured test-wise as a repeater, occurs on a random basis.

7. The method of claim 1, wherein in the second task, multiple peripheral stations are configured test-wise as repeaters, and the test-wise configuration is changed until all reachable peripheral stations are reached using a minimal number of repeaters.

8. A central station of a wireless network, comprising:
a central station arrangement, the wireless network including at least the central station arrangement and at least two peripheral stations;
wherein the central station is configured to perform the following:
ascertaining, in a first task, the peripheral stations, which are reachable by wireless signals of the central station;
configuring, in a second task, at least one of the peripheral stations, which was ascertained in the first task, test-wise as a repeater, which receives wireless signals of the central station and re-transmits them, and ascertaining whether more peripheral stations are reachable by the central station via the repeater; and
if this is the case, in a third task, the peripheral stations which were configured test-wise as repeaters, are permanently configured as repeaters.
